(19) United States
(12) Patent Application Publication
(10) Pub. No.: US 2005/0206800 A1
(43) Pub. Date: Sep. 22, 2005

(54) Line-illuminating device and image-scanning device incorporating the same

(75) Inventors: Masahide Wakisaka, Tokyo (JP); Makoto Ikeda, Tokyo (JP)

Correspondence Address: CARRIER BLACKMAN AND ASSOCIATES, 24101 NOVI ROAD, SUITE 100, NOVI, MI, 48375, US

(73) Assignee: Nippon Sheet Glass Co., Ltd., Tokyo (JP)

(21) Appl. No.: 11/057,652

(22) Filed: Feb. 14, 2005

(30) Foreign Application Priority Data
Mar. 17, 2004 (JP) 2004-077094

(51) Int. Cl. G02F 1/1333

(52) U.S. Cl. 349/58

(57) ABSTRACT

A line-illuminating device is provided in an image-scanning device such that the end of a transparent light guide is not disengaged from a casing and uniformity of the light amount can be achieved. A rib is formed unitarily with a resin mold which constructs a light source unit so as to cover an end of a light-emitting plane of the transparent light guide. The end of the light guide can be prevented from being disengaged from the casing by the rib. Another rib is formed unitarily with the end of the casing on the opposite side of the light source unit. This rib covers an opposite end of the light-emitting plane of the transparent light guide, and prevents the opposite end of the light guide from being disengaged from the casing.

### BACKGROUND OF THE INVENTION

1. Field of the Invention

The present invention relates to a line-illuminating device, and a contact-type or reduced-type image-scanning device (image sensor) in which the line-illuminating device is incorporated.

2. Description of the Prior Art

An image-scanning device such as a facsimile machine, a copying machine, and an image scanner is provided with a line-illuminating device for linearly illuminating a document surface along a main scanning field.

Document 1 has proposed a line-illuminating device in which a bar-shaped or plate-shaped transparent light guide is housed within a casing, a light source unit is provided at an end, and light incident on the end surface of the light guide is reflected on the internal surface so as to be emitted from a light-emitting plane in a longitudinal direction which is exposed from the casing.

Document 2 has proposed that a recessed portion is provided on one of a casing and a transparent light guide, and a projected portion to be engaged in the recessed portion is provided on the other, so that positioning can be easily performed at the time of incorporating the transparent light guide in the casing.
[Document 1] Japanese Patent Application Publication No. 8-163320
[Document 2] Japanese Patent Application Publication No. 10-126581, Paragraphs 0025 and 0036, FIGS. 3 and 6

FIG. 6(a) is a cross-sectional view of the end of a line-illuminating device adjacent to a light source unit, and this shows an ideal state where no gap is generated. However, since a transparent light guide is manufactured by conducting injection molding to a resin material such as a polyolefin-based material, it takes more time to cool a thick portion compared to other portions, and consequently warpage occurs. If a light guide in which warpage has occurred is housed within a casing, a gap is generated between the end of the light guide and the light source unit, and between the end of the light guide and the internal surface of the casing.

In the case where warpage has occurred, even if the light guide is housed within the casing, the end of the light guide protrudes the casing. Also, the gap generated due to the warpage causes non-uniformity of the light amount. Additionally, it is laborious work to find this defect by inspection. Further, as mentioned above, the projected and recessed portions, which have been disclosed in Document 2, are for positioning the light guide with respect to the casing. However, they cannot prevent the end of the light guide from being disengaged from the casing nor a gap from being generated.

### SUMMARY OF THE INVENTION

To solve the above-mentioned problems, according to the present invention, there is provided a line-illuminating device comprising a transparent light guide having a bar shape or a plate shape, a casing for housing the transparent light guide such that a light-emitting plane of the light guide is exposed from the casing, and a light source unit which is provided at at least one end of the light guide, wherein light incident on the end surface of the light guide is reflected on the internal surface of the light guide so as to be emitted from the light-emitting plane, and wherein the line-illuminating device further comprises a rib for catching the light-emitting plane of the light guide which is provided in at least one of the light source unit and the casing.

The rib may be formed unitarily with respect to the casing, or may be formed separately from the casing and then assembled to be unitary. When the rib is formed separately from the casing, it is easy to modify the design of the rib shape.

The casing and the rib are preferably white. With this, uniform illuminance can be obtained. Also, the present invention can effectively be applied to a case where the light guide is fixed by two or three planes of the casing. If the light guide is fixed by four planes of the casing, disengagement due to warpage hardly occurs. However, when the light guide is put into the casing, the light guide needs to be pushed into the casing from one end thereof while rubbing against the casing. This causes scratches on the lens surface, and scattering unpreferably occurs.

The line-illuminating device may have a structure in which light source units are provided at both ends instead of one end. The present invention includes an image-scanning device which incorporates two line-illuminating devices as well as only one line-illuminating device.

### BRIEF DESCRIPTION OF THE DRAWINGS

FIG. 1 is a cross-sectional view of an image-scanning device which incorporates a line-illuminating device according to the present invention;

FIG. 2 is a perspective view of the line-illuminating device;

FIG. 3 is a perspective view of a light source unit;

FIG. 4 is a cross-sectional view of the end of the line-illuminating device adjacent to the light source unit;

FIG. 5 is a cross-sectional view of the line-illuminating device in the longitudinal direction; and

FIG. 6(a) is a cross-sectional view of the end of the line-illuminating device adjacent to the light source unit in a state where no gap is generated and FIG. 6(b) is a cross-sectional view of the end of the line-illuminating device adjacent to the light source unit in a state where a gap is generated.

### DETAILED DESCRIPTION OF THE PREFERRED EMBODIMENTS

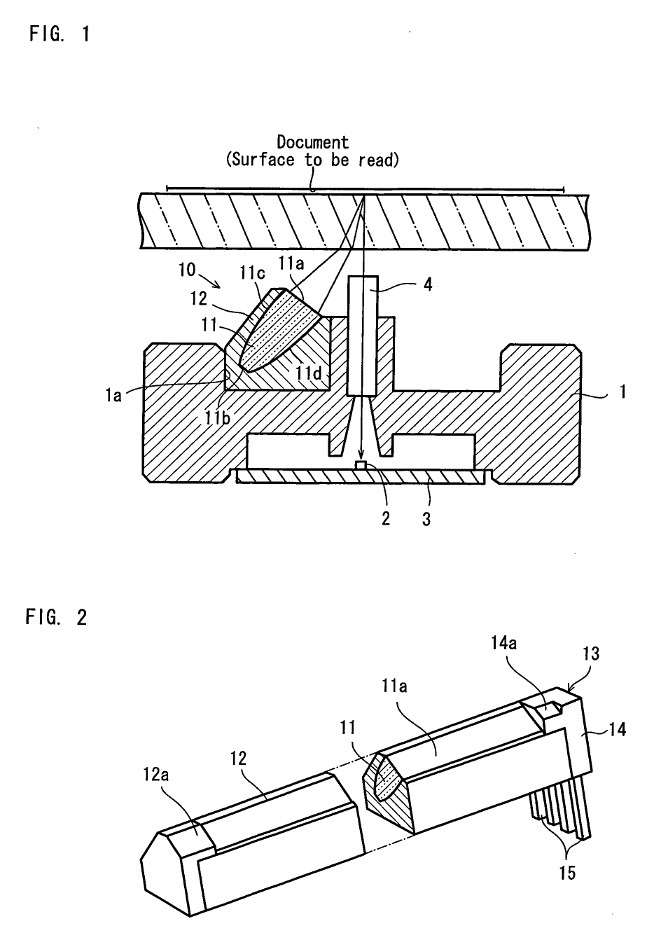

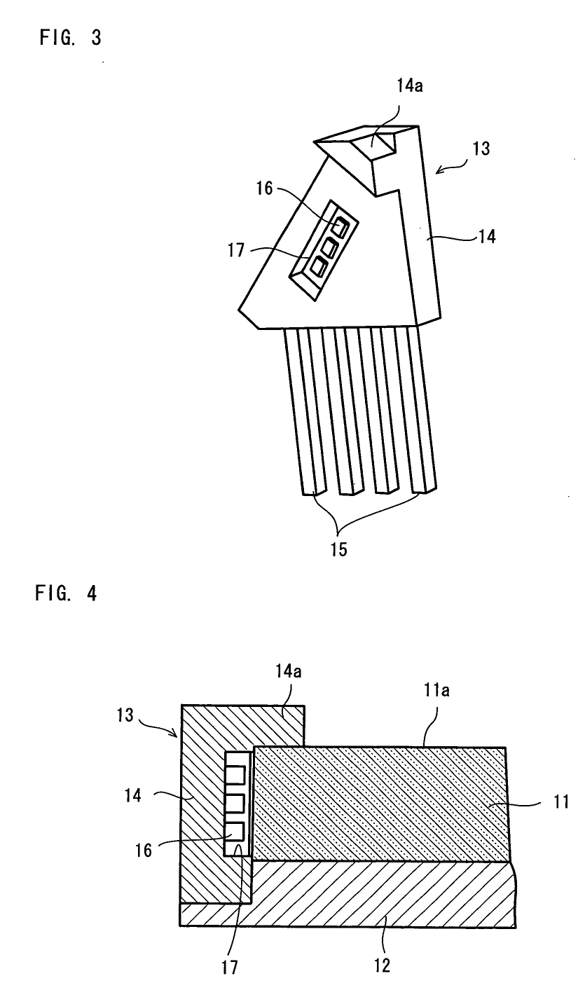

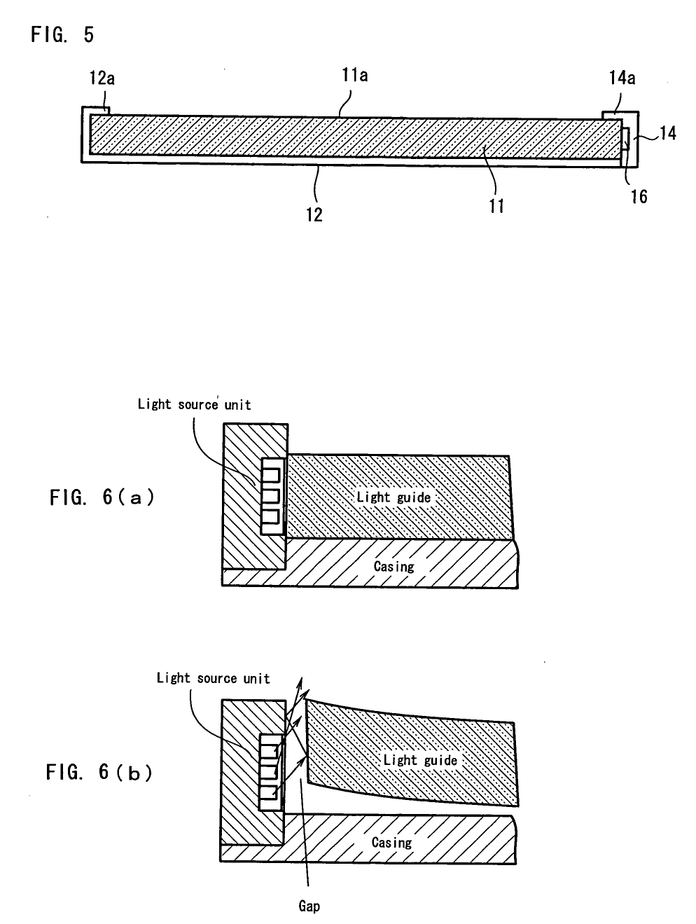

Preferred embodiments of the present invention will now be described with reference to the accompanying drawings. FIG. 1 is a cross-sectional view of an image-scanning device which incorporates a line-illuminating device according to the present invention, FIG. 2 is a perspective view of the line-illuminating device, FIG. 3 is a perspective view of a light source unit, FIG. 4 is a cross-sectional view of the end of the line-illuminating device adjacent to the light source unit, and FIG. 5 is a cross-sectional view of the line-illuminating device in the longitudinal direction.

The image-scanning device is provided with a line-illuminating device 10 within a recessed portion 1a which is formed in a frame 1, and a sensor base plate 3 on which a photoelectric transducer element (line image sensor) 2 is mounted is disposed in the bottom. A rod lens array 4 for unit magnification is disposed in the center of the frame 1 so as to converge light which is emitted from the line-illuminating device 10 and reflected by a document on the photoelectric transducer element 2.

The line-illuminating device 10 is comprised of a transparent light guide 11 having a bar shape or a plate shape and made of an acrylic resin, a white casing for housing the transparent light guide 11, and a light source unit 13 which is provided in one end of the casing 12. The transparent light guide 11 has two kinds of reflecting curved planes 11c and 11d. The cross-sectional shape of these curved planes in the direction perpendicular to the longitudinal direction is an elliptic arc or a parabola, and light from a plane 11b is emitted from a light-emitting plane 11a which is exposed from the casing 12. A light scattering pattern may be formed in the plane 11b, so that the intensity of the emitted light can be uniform.

However, the shape of the light guide is not limited to the above. Another shape is possible, for example, in which the cross-sectional shape in the direction perpendicular to the longitudinal direction is substantially ¼ oval whose end of the major axis is chamfered, the focal point of the oval is within the chamfered plane, and the basic shape of the chamfered plane, which serves as a light-emitting plane 11a, is a rectangle having a chamfered corner.

Incidentally, in the embodiment shown in the drawing, only one line-illuminating device 10 is disposed. However, two line-illuminating devices 10 may be disposed on both sides of the rod lens array 4.

The light source unit 13 comprises a resin mold 14, and lead terminals 15 and a plate-shaped lead frame which are made by insert molding. The light source unit 13 further comprises a window 17 for mounting light-emitting elements (LED) 16.

A rib 14a is formed unitarily with the resin mold 14. The rib 14a is positioned so as to catch the light-emitting plane 11a of the transparent light guide 11, and the size of the rib 14a in the longitudinal direction is 0.5-3 mm. If the size is less than 0.5 mm, the end of the light guide 11 might be disengaged from the casing due to warpage, and the effect of controlling non-uniformity of the light amount cannot be achieved. If the size is more than 3 mm, it becomes difficult to mount the light-emitting element, and the cost is increased because the length of the material is increased.

Also, a rib 12a is formed unitarily with the end of the casing on the opposite side of the light source unit 13. The rib 12a is positioned so as to catch the light-emitting plane 11a of the transparent light guide 11, and the size of the rib 12a in the longitudinal direction is 0.5-3 mm in the same manner as the rib 14a. Incidentally, the light amount might be decreased in the end on the side of the rib 12a because there is no light source unit on this side. In this instance, it is possible to achieve uniformity of the light amount by making the rib 12a shorter than the rib 14a so as to decrease the area for covering the light-emitting plane 11a.

As mentioned above, according to the present invention, the transparent light guide can be housed within the casing securely without fabricating the transparent light guide and the casing with high accuracy, and the positioning accuracy can be achieved.

In particular, even if slight warpage of the light guide occurs, the light guide is fixed within the casing in a state where the warpage is corrected by the rib, and thereby hardly any gap is generated between the end of the transparent light guide and the light source unit, and between the end of the transparent light guide and the casing. If a slight gap is generated, it is possible to prevent scattered light from leaking out by the rib. Consequently, non-uniformity of the light amount in the longitudinal direction of the line-illuminating device can be reduced, and an insufficient light amount can be overcome.

1. A line-illuminating device comprising:
a transparent light guide having a bar shape or a plate shape;
a casing housing the transparent light guide such that a light-emitting plane of the light guide is exposed from the casing;
a light source unit provided at at least one end of the light guide,
such that light incident on an end surface of the light guide is reflected on an internal surface of the light guide so as to be emitted from the light-emitting plane; and
which catches the light-emitting plane of the light guide and is provided in at least one of the light source unit and the casing.

2. The line-illuminating device according to claim 1, wherein the rib is formed unitarily with respect to the casing, or formed separately from the casing and then assembled to be unitary therewith.

3. An image-scanning device comprising the line-illuminating device according to claim 1, a line image sensor which is constructed of a photoelectric transducer element, and a lens array for converging light which is emitted from the line-illuminating device and reflected by a document on the line image sensor.

4. An image-scanning device comprising the line-illuminating device according to claim 2, a line image sensor which is constructed of a photoelectric transducer element, and a lens array for converging light which is emitted from the line-illuminating device and reflected by a document on the line image sensor.

5. The line-illuminating device according to claim 1, wherein the rib is provided in the light source unit.

6. The line-illuminating device according to claim 1, comprising a pair of said ribs provided in said light source unit and said casing, respectively, and said ribs engage the light-emitting plane at opposite ends of the light guide.

7. The line-illuminating device according to claim 1, wherein the rib is formed integrally with a resin mold of the light source unit.

8. The image-scanning device according to claim 3, wherein the rib is provided with the light source unit.

9. The image-scanning device according to claim 3, comprising a pair of said ribs provided with said light source unit and said casing, respectively, and said ribs engage the light-emitting plane at opposite ends of the light guide.

10. The image-scanning device according to claim 3, wherein the rib is formed integrally with a resin mold of the light source unit.
